(19) United States
(12) Patent Application Publication
(10) Pub. No.: US 2020/0109559 A1
(43) Pub. Date: Apr. 9, 2020

(54) MINIMAL MULLION FAÇADE ASSEMBLY

(71) Applicant: GOLDBRECHT INC., Culver City, CA (US)

(72) Inventors: Marcel FONTIJN, Culver City, CA (US); Joshua Steven RAY, Los Angeles, CA (US)

(73) Assignee: GOLDBRECHT INC., Culver City, CA (US)

(21) Appl. No.: 16/592,140

(22) Filed: Oct. 3, 2019

Related U.S. Application Data
(60) Provisional application No. 62/741,091, filed on Oct. 4, 2018.

(51) Int. Cl. E04B 2/90; E06B 3/54

(52) U.S. Cl. CPC E04B 2/90; E06B 3/5454

(57) ABSTRACT

Provided is a curtain wall assembly including a first panel, and a second panel that is adjacent to the first panel. The curtain wall assembly includes a first attachment member attached to the first panel, and a second attachment member attached to the second panel. Each of the first attachment member and the second attachment member include at least one fin, and the first attachment member is secured to the second attachment member at the fin.

### CROSS-REFERENCE TO RELATED APPLICATION(S)

This application claims is based on and claims priority under 35 U.S.C. § 119 to U.S. Application No. 62/741,091, filed on Oct. 4, 2018, in the U.S. Patent & Trademark Office, the disclosure of which is incorporated by reference herein in its entirety.

### BACKGROUND

### 1. Field

Exemplary embodiments relate to doors and windows, and more particularly, to an assembly that provides a narrower front view section and improved thermal performance of the windows and doors.

### 2. Description of Related Art

Conventional methods and apparatuses for installing doors and windows use metal fasteners to attach glass through the façade.

Conventional apparatuses require the use of metal or similar conductive materials to travel from the exterior face of the glass to the interior face of the glass. Further, the fasteners are provided between the two panels, creating a large space. These conventional designs result in poor thermal performance and create a bulky look to the front view section of the façade.

Exemplary embodiments overcome these shortcomings and address the problems associated with the prior methods and apparatuses for installing side-by-side glass panels. The exemplary embodiments provide an assembly for attaching adjacent glass panels by removing fasteners going through a space between the two adjacent panels and eliminating metal or similar conductive materials from traveling from the exterior face of the glass to the interior face of the glass.

### SUMMARY

According to an aspect of the disclosure, a curtain wall assembly may include a first panel, and a second panel that is adjacent to the first panel. The curtain wall assembly may include a first attachment member attached to the first panel, and a second attachment member attached to the second panel. Each of the first attachment member and the second attachment member include at least one fin, and the first attachment member is secured to the second attachment member at the fin.

### BRIEF DESCRIPTION OF THE DRAWINGS

These and/or other aspects will become apparent and more readily appreciated from the following description of exemplary embodiments, taken in conjunction with the accompanying drawings of which:

FIG. 1A is a diagram illustrating a front view of a plurality of panels according to an exemplary embodiment;

FIG. 1B is a diagram illustrating a side view of a plurality of panels according to an embodiment;

FIGS. 2A through 2C are views of an attachment mechanism for adjacent panels according to an exemplary embodiment;

FIG. 3A is a diagram illustrating a front view of an operable system having an integrated hinge for an awning or casement according to another exemplary embodiment, in which the awning or the casement is in a closed position;

FIG. 3B is a diagram illustrating a side view of an operable system having an integrated hinge for an awning or casement according to another exemplary embodiment, in which the awning or the casement is in an open position;

FIG. 4A is a diagram illustrating an operable system having an integrated hinge for an awning or casement according to another exemplary embodiment, in which the awning or casement is in a closed position; and

FIG. 4B illustrates an operable system having an integrated hinge for an awning or casement according to another exemplary embodiment, in which the awning or casement is in an open position.

### DETAILED DESCRIPTION

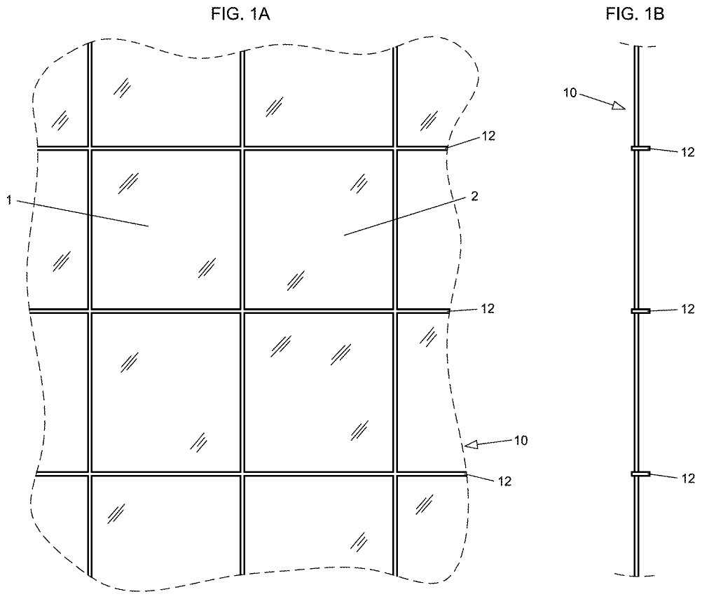

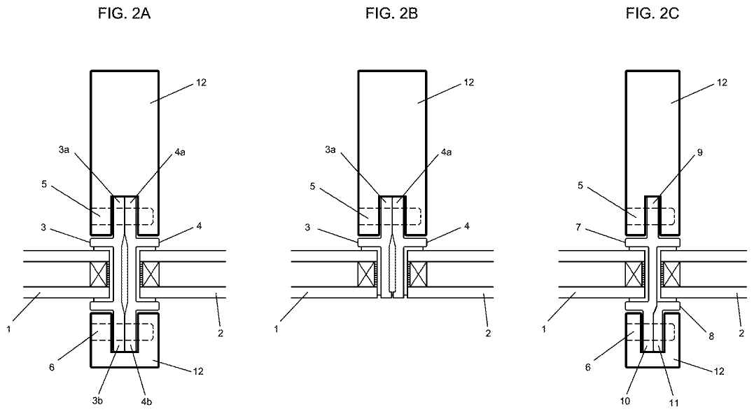

FIG. 1A is a front view of a curtain wall assembly 10, and FIG. 1B is a side view of the curtain wall assembly 10. As shown in the drawings, with reference made to the reference numerals in FIGS. 1A and 1B, the curtain wall assembly 10 is provided with a first panel 1 adjacent to a second panel 2. According to an exemplary embodiment, each of the first panel 1 and the second panel 2 is formed of glass. However, as will be understood by one of ordinary skill in the art, the first panel 1 and the second panel 2 can be formed of any material suitable for windows and/or transparent or semi-transparent portions of doors. As further shown in FIGS. 1A and 1B, a frame 12 is configured to support the panel 1 and the panel 2. As shown in FIG. 2A, the attachment mechanism for attaching the adjacent first panel 1 to the second panel 2 is illustrated. According to an exemplary embodiment, a first attachment member 3 is connected to the first panel and a second attachment member 4 is connected to the second panel 2. It will be understood that any method known to one of ordinary skill in the art can be used to connect the first attachment member 3 and the second attachment member 4 to the first panel 1 and the second panel 2, respectively. However, in order to improve the thermal performance of windows and doors, no metal is provided between the panels and the attachment members in an embodiment. Further, according to an exemplary embodiment, the first attachment member 3 and the second attachment member 4 can be made of any suitable rigid material of reduced thermal conductivity.

Each of the first attachment member 3 and the second attachment member 4 is provided with at least one fin 3a and 4a, respectively. Each fin 3a, 4a protrudes from the respective attachment member in a direction perpendicular to the first panel 1 and the second panel 2. Further, each fin 3a and 4a extends into a recess formed in the frame 12. The fin 3a may be integrated to first attachment member 3, and the fin 4a may be integrated to the second attachment member 4. In this case, the fin 3a and the fin 4a may be formed of the same material as the first attachment member 3 and the second attachment member 4, respectively. Alternatively, in other implementations, the fin 3a and the fin 4a may be formed separately from the first attachment member 3 and the second attachment member 4, and/or may be formed of different materials than the first attachment member 3 and the second attachment member 4.

While not shown, fin 3a and fin 4a are each provided with a through opening. A capture device 5 is provided through the opening of fins 3a and 4a, and attaches the first attachment member 3 to the second attachment member 4. Further, the capture device 5 attaches the first attachment member 3 and the second attachment member 4 to the frame 12. According to a non-limiting exemplary embodiment, when attached together, the thickness of the first attachment member 3 and the second attachment member 4 in the horizontal direction (e.g., shown as left to right in FIG. 2A) is preferably equal to or less than 1.25 inches. It will be understood that the thickness is not limited to this exemplary embodiment. In this manner, the first panel 1 and the second panel 2 are attached adjacent to each other to reduce the space, thereby improving the front view of the façade.

As shown in FIG. 2A, the first attachment member 3 and the second attachment member 4 can be substantially U-shaped, but are not limited to this shape. According to an exemplary embodiment, this shape allows the attachment member 3 and the attachment member 4 to contact three sides of the panel 1 and the panel 2 and increase the strength of the connection.

As shown in FIG. 2B, and according to another example embodiment, the first attachment member 3 and the second attachment member 4 can be substantially L-shaped. In this way, the L-shape permits the first attachment member 3 and the second attachment member 4 to contact two sides of the panels 1 or 2, respectively. Further in this case, the first attachment member 3 and the second attachment member 4 connect to a single portion of the frame 12, instead of multiple portions of the frame 12 as shown in FIGS. 2A and 2C.

As shown in FIG. 2A, and according to yet another exemplary embodiment, the first attachment member 3 and the second attachment member 4 may each include a second fin 3b, 4b opposite the first fins 3a, 4a. The second fin 3b and the second fin 4b may extend into a recess formed in the frame 12. The second fins 3b, 4b can each include a through hole and are attached together by an additional capture device 6, thereby improving the connection between the panels. The additional capture device 6 may attach the first attachment member 3 and the second attachment member 4 to the frame 12.

As shown in FIG. 2C, the first attachment member 3 and the second attachment member 4 may be integrated to form an integrated attachment member 7. The integrated attachment member 7 may include an integrated fin 9, and a second fin 10. Further, a second attachment member 8 with a third fin 11 may be provided so as to correspond to the second fin 10.

The integrated fin 9 may extend into a recess formed in the frame 12. As shown, a capture device 5 is provided through an opening of the integrated fin 9 of the integrated attachment member 7 to anchor the integrated fin 9 and the integrated attachment member 7 to the frame 12. As further shown, an additional capture device 6 is provided through openings of the second fin 10 and the third fin 11 to anchor the second fin 10 and the third fin 11 to the frame 12. The capture device 5 and/or the additional capture device 6 may be formed of any suitable material, such as metal, a plastic, a composite, and/or the like.

As will be understood by one of ordinary skill in the art, the attachment members may be provided between any two adjacent panels. This arrangement provides strength to the panel assembly, while simultaneously improving the thermal properties and the façade of the panels.

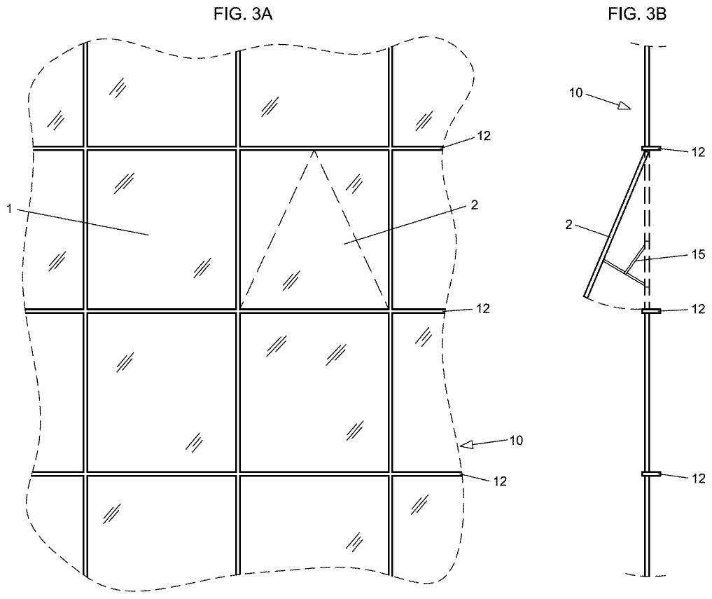

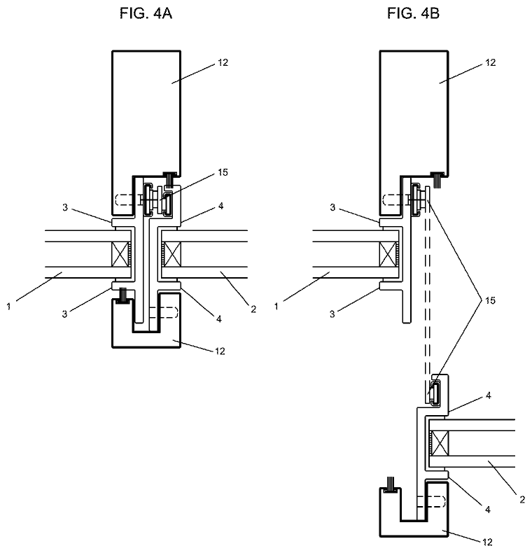

According to an exemplary embodiment, and as shown in FIGS. 3A, 3B, 4A, and 4B, the second panel 2 of curtain wall assembly 10 is configured to move with respect to the first panel 1. The movement is facilitated by a side of the second panel 2 opposite the first attachment member 3 rotating away from the plane in which the first panel 1 is disposed using a hinge 15. The hinge 15 may be connected to the first attachment member 3 and the second attachment member 4 and allows the first attachment member 3 to move with respect to the second attachment member 4.

As shown in FIG. 3B, the second panel 2 may move with respect to the first panel 1 via the hinge 15. Specifically, the second panel 2 connected to the hinge 15 may rotate with respect to the first panel 1 connected to hinge 15. The hinge 15 may extend vertically and/or horizontally.

As shown in FIG. 4A, the hinge 15 may be attached to the first attachment member 3 and the second attachment member 4. As shown, the first attachment member 3 may be attached to a first frame portion 12 (shown at the top of the page), and may be removably connected to a second frame portion 12 (shown at the bottom of the page). Further, the second attachment member 4 may be removably connected to the first frame portion 12 and the first attachment member 3 via the hinge 15. As further shown, the second attachment member 4 may be connected to the second frame portion 12.

As shown in FIG. 4B, the second attachment member 4 may be removably disconnected from the first attachment member 3 via the hinge 15. That is, the second attachment member 4 may rotate with respect to the hinge 15, and rotate outwardly with respect to the first panel 1.

What is claimed is:

1. A curtain wall assembly, comprising:
a first panel;
a second panel, adjacent to the first panel;
a first attachment member attached to the first panel; and
a second attachment member attached to the second panel,
wherein each of the first attachment member and the second attachment member include at least one fin, and
the first attachment member is secured to the second attachment member at the fin.

2. The curtain wall assembly of claim 1, wherein the first attachment member is bonded to the first panel, and
the second attachment member is bonded to the second panel.

3. The curtain wall assembly of claim 1, wherein each fin of the first attachment member and the second attachment member is provided with a through opening, and
the first attachment member is secured to the second attachment member by a capture device provided in the through opening.

4. The curtain wall assembly of claim 3, wherein the capture device is parallel to the first panel and the second panel.

5. The curtain wall assembly of claim 1, wherein the first attachment member and the second attachment member are each formed of a rigid material of reduced thermal conductivity.

6. The curtain wall assembly of claim 1, wherein, in an assembled position, no metal is provided between the first panel and the second panel.

7. The curtain wall assembly of claim 1, wherein the first panel and the second panel are each formed of glass.

8. The curtain wall assembly of claim 1, wherein a thickness of the first attachment member in a direction parallel to the first panel and a thickness of the second attachment member in the direction parallel to the first panel is equal to or less than 1.25 inches.

9. The curtain wall assembly of claim 1, wherein the first attachment member includes a U-shaped channel and the first attachment member contacts at least three sides of the first panel when attached to the first panel.

10. The curtain wall assembly of claim 1, wherein the first attachment member includes a L-shaped channel and the first attachment member contacts at least two sides of the first panel when attached to the first panel.

11. The curtain wall assembly of claim 1, wherein the second attachment member includes a U-shaped channel and the second attachment member contacts at least three sides of the second panel when attached to the second panel.

12. The curtain wall assembly of claim 1, wherein the second attachment member includes a L-shaped channel and the second attachment member contacts at least two sides of the second panel when attached to the second panel.

13. The curtain wall assembly of claim 3, wherein first attachment member and the second attachment member each include a second fin, opposite the at least one fin,
each second fin is provided with a through hole, and
an additional capture device is provided through the through hole of each second fin to attach the second fin of the first attachment member and the second attachment member together.

14. The curtain wall assembly of claim 1, wherein the first attachment member includes a first fin and a second fin,
wherein the second attachment member includes a third fin, and
wherein the first attachment member and the second attachment member are attached via the second fin and the third fin.

15. The curtain wall assembly according to claim 1, wherein
the first panel is configured to move with respect to the second panel.

16. The curtain wall assembly according to claim 12, wherein
a side of the first panel opposite the first attachment member rotates away from the plane in which the second panel is disposed.

17. The curtain wall assembly according to claim 13, wherein
a hinge is connected to the first attachment member and the second attachment member and allows the first attachment member to move with respect to the second attachment member.
